(19) United States
(12) Patent Application Publication
(10) Pub. No.: US 2009/0114759 A1
(43) Pub. Date: May 7, 2009

(54) Attachment for Securing a Leash to a Roll

(75) Inventor: Manfred Bogdahn, Hamburg (DE)

Correspondence Address: HOWSON & HOWSON LLP, 501 OFFICE CENTER DRIVE, SUITE 210, FORT WASHINGTON, PA, 19034, US

(73) Assignee: FLEXI-BOGDAHN TECHNIK GMBH & CO. KG, Bargteheide (DE)

(21) Appl. No.: 12/255,183

(22) Filed: Oct. 21, 2008

(30) Foreign Application Priority Data
Nov. 2, 2007 (DE) 20 2007 015 226.4

(51) Int. Cl. B65H 75/28; A01K 27/00

(52) U.S. Cl. 242/579; 119/796

(57) ABSTRACT

An attachment for securing a leash on a roll is provided. The roll is attached rotatably in a housing, whose wall facing the roll is arranged at a separation from the peripheral surface of the roll. The leash passes through an opening in the wall out of the housing and is attached on the roll via a terminal loop. The loop is formed by a folded-over terminal leash section that is secured to the leash itself. According to the invention, it is proposed that with formation of the loop, the attachment of the leash end to the leash lies in or in front of the opening in the pull-out direction outside the housing in the fully unwound state of the leash.

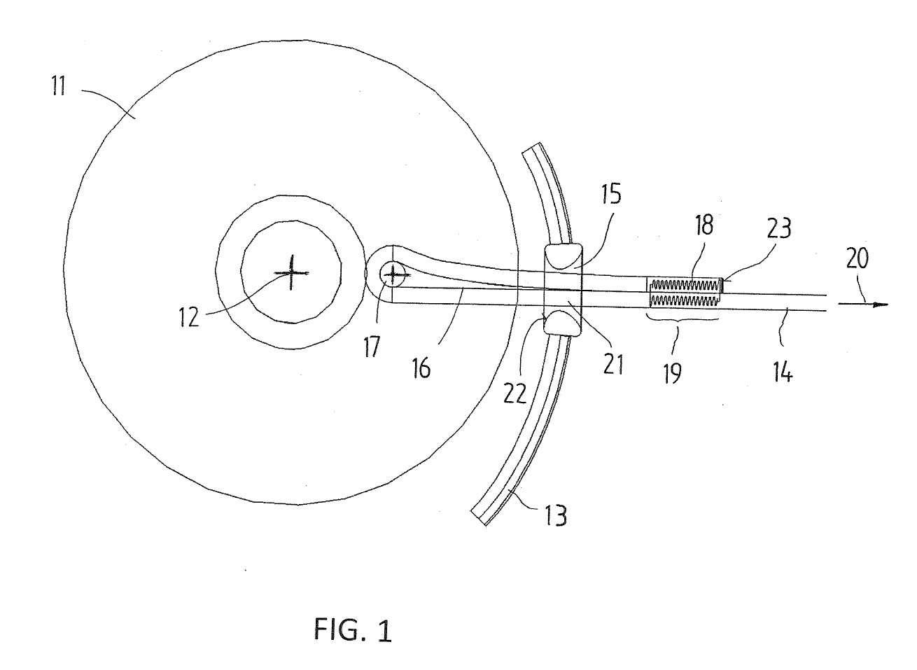

### BACKGROUND OF THE INVENTION

The invention relates to an attachment for securing a leash to a roll, which is rotatably attached in a housing, whose wall facing the roll is arranged at a separation from the peripheral surface of the roll, which leash passes through an opening in the wall out of the housing and is attached with a terminal loop to the roll, which loop is formed by folding over the terminal leash section and securing the leash end to the leash itself. The invention relates particularly to dog leashes, where the leash can be wound up on and unwound from a roll. Therefore, the discussion will refer primarily to a dog leash, although there is no limitation connected with this.

The term attachment refers to the area in which the leash end is connected to the leash. Here it is generally a leash section with a length of 0.5-2 cm, by which the leash end is connected to the leash. The discussion below relates mostly only to the attachment.

Such an attachment of a leash to a roll is used, for example, with leashes that can be wound up and unwound to guide animals, as known from EP 0 941 657 B1. The housing that receives the leash and the roll presents a handle to carry the leash device. A brake device is present to keep the leash at the desired length. The brake device is provided additionally with a latching device to keep the brake device in the stopped state. The leash then remains in a state where it is unwound to the desired length. It is naturally also possible for the leash to be completely unwound. Then the leash is held by the roll itself when the maximum pull-out length has been reached.

With such leashes it is unavoidable for the leash to rub against the inner walls of the opening, which results in wear of the leash. In addition to this wear, there is the increased tensile load when the leash is being held. From DE 20 2006 002 147 U1 it is known to design the opening so it is movable relative to the housing. Due to the movement of the outlet opening in the direction of tension, the forces that act on the leash are reduced. However, it is relatively complicated to mount the leash because the attachment must be arranged as close as possible to the leash end in order to form a smaller loop. The mounting thus requires certain dexterity.

### SUMMARY OF THE INVENTION

The invention is therefore based on the problem of designing an attachment to secure a leash on a roll in such a way that among other things the mounting of the leash is simplified.

The problem is solved according to the invention by the fact that the attachment of the leash end to the leash is located in or in front of the opening outside the housing with the formation of a loop when the leash is fully unwound in the pull-out direction. This has the advantage that the leash presents a relatively large loop and can thus be mounted easily.

The leash can be configured in the form of a rope or as a belt. With a leash in the form of a rope, the frictional force is distributed over two ropes when the leash is completely unwound, so that here the friction force acting on each individual rope is decreased when the leash is completely pulled out.

The leash end can be sewn to the leash forming the loop. This type of attachment is durable and it can be manufactured with relatively simple means. It is also possible, particularly when using synthetic fibers for the leash, to glue or fuse the leash end to the leash. The leash end can also be glued or fused and also sewn to the leash.

It is possible to provide for the length of the loop to be chosen such that in the completely unwound state the attachment in the pull-out direction is partially inside the opening. However, it is advantageous for the length of the loop to be chosen such that in the fully unwound state the attachment in the pull-out direction is located at some separation, particularly 1-10 cm, in front of the opening outside of the housing. Then, the attachment area is located outside the opening, and it does not rub against the inner wall. There is no risk of a loosening of the attachment.

Finally, it has been found that the passage of the leash through the opening is not prevented due to the double-layer design. However, one can also provide for the leash to be sewn particularly strongly to the front side of the end, or for it to be configured so it is flat, which allows the leash to slide through more easily. In addition, the outlet opening can be configured alternatively so that it tapers conically in the direction of tension on its side facing the roll. This also facilitates the passage of the thickened double-layered section of the leash.

The loop can be attached to the roll by any means. It is advantageous for the loop to be held on the roll with a pin that runs eccentrically with respect to the rotation axis of the roll. A pin is here held in lateral flanges, which delimit the roll laterally with formation of the winding space for the leash. This type of attachment has been shown to be satisfactory, and it can withstand strong tensile loads.

### BRIEF DESCRIPTION OF THE DRAWING

The invention is explained in greater detail below using the schematic drawing. The single figure shows a leash device with a roll and the associated housing section with the outlet opening for the leash.

### DETAILED DESCRIPTION OF THE INVENTION

The leash device that is represented in the drawing presents a roll 11, which is attached rotatably about an axle 12 in a housing 13 that is not completely drawn. A spring can be present, against whose force the leash 14 can be unwound and, as a result of its restoring force, the leash can be rewound on the roll. In addition, braking devices can be present to hold the leash at the desired length. The housing presents a handle to carry the leash device. Moreover, the housing presents an outlet opening 15 through which the leash is led out of the housing. To that extent such a leash is known as a dog leash that can be wound up and unwound, and no further explanation is required.

The drawing shows the leash in the completely unwound state. The attachment of the leash 14 occurs by means of a loop 16, which is held by a pin 17 that is eccentric with respect to the rotation axis 12 on the roll 11 in the middle inner area of the latter. By turning the roll 11 in one or the other direction, the leash is rolled on or off.

The loop 16 is formed by folding over the leash end 18. The terminal leash end 18 is connected, for example by sewing, to the leash 14, in an attachment area 19.

As far as the details of the arrangement are concerned, the length of the loop is chosen in such a way that the attachment 19 in the represented completely unwound state lies in the traction direction 20 in front of the outlet opening 15 outside the housing. This has the effect that the area 21, which in the completely unwound state lies against the inner wall of the outlet opening 15, is configured with a double layer. If the leash is configured as a rope with an essentially round cross section, the two rope sections lie next to each other in the opening. If the leash is configured as a belt, the belt sections lie on top of each other.

The opening 15 is here configured so that it tapers conically in the traction direction 20 on its side 22 facing the roll 11. This facilitates the passing of the double layered loop section and of the above-mentioned front end 23 through the opening.

1. Attachment for securing a leash (14) on a roll (11), which is attached rotatably in a housing, whose wall (13) facing the roll is arranged at a separation from the peripheral surface of the roll (11), which leash passes through an opening (15) in the wall (13) out of the housing and is attached with a terminal loop (16) to the roll (11), which loop (16) is formed by folding over a terminal leash end section (18) and securing the terminal leash end section (18) to the leash (14) itself, characterized in that with formation of the loop (16), the attachment (19) of the leash end section (18) to the leash (14) lies in front of the opening (15) in a pull-out direction (20) outside the housing in a fully unwound state of the leash (14).

2. An attachment according to claim 1, wherein the leash (14) is in the form of a rope or a belt.

3. An attachment according to claim 2, wherein the leash end section (18) is sewn to the leash (14) during formation of the loop (16).

4. An attachment according to claim 3, wherein the leash end section (18) is glued or fused to the leash (14).

5. An attachment according to claim 4, wherein a length of the loop (16) is such that, in the fully unwound state, the attachment (19) in the pull-out direction (20) lies partially within the opening (15).

6. An attachment according to claim 4, wherein a length of the loop (16) is such that, in the fully unwound state, the attachment (19) lies in the pull-out direction (20) with a small separation of 1 to 10 cm in front of the opening (15) outside the housing.

7. An attachment according to claim 6, wherein the outlet opening (15) is configured so that it tapers conically in a direction of tension on a side (22) facing the roll (11).

8. An attachment according to claim 7, wherein the loop (16) is held on the roll (11) with a pin (17) that runs eccentrically with respect to a rotation axis (12) of the roll (11).

9. An attachment according to claim 1, wherein the leash end section (18) is sewn to the leash (14) during formation of the loop (16).

10. An attachment according to claim 1, wherein the leash end section (18) is glued or fused to the leash (14).

11. An attachment according to claim 1, wherein a length of the loop (16) is such that, in the fully unwound state, the attachment (19) in the pull-out direction (20) lies partially within the opening (15).

12. An attachment according to claim 1, wherein a length of the loop (16) is such that, in the fully unwound state, the attachment (19) lies in the pull-out direction (20) with a small separation of 1 to 10 cm in front of the opening (15) outside the housing.

13. An attachment according to claim 1, wherein the outlet opening (15) is configured so that it tapers conically in a direction of tension on a side (22) facing the roll (11).

14. An attachment according to claim 1, wherein the loop (16) is held on the roll (11) with a pin (17) that runs eccentrically with respect to a rotation axis (12) of the roll.

15. An attachment for a leash, comprising:
a leash (14) secured on a roll (11) having a peripheral surface, said leash (14) being in the form of a rope or belt; and
a housing in which the roll (11) is secured and rotatable, said housing having a wall (13) facing the roll (11) and spaced from the peripheral surface of the roll (11), said wall (13) having an opening (15) through which the leash (14) passes out of the housing;
said leash (14) being attached with a terminal loop (16) to the roll (11), said loop (16) comprising a terminal end section (18) of said leash (14) folded over and secured to the leash (14) itself at an attachment (19);
said attachment (19) of the terminal end section (18) to the leash (14) lies in or in front of the opening (15) in a pull-out direction (20) outside the housing in a fully unwound state of the leash (14).

16. An attachment according to claim 15, wherein the terminal end section (18) is sewn, glued, or fused to the leash (14).

17. An attachment according to claim 16, wherein a length of the loop (16) is such that, in the fully unwound state, the attachment (19) in the pull-out direction (20) lies partially within the opening (15) or 1 to 10 cm in front of the opening (15) outside the housing.

18. An attachment according to claim 17, wherein the outlet opening (15) is configured so that it tapers conically in a direction of tension on a side (22) of the opening (15) facing the roll (11).

19. An attachment according to claim 18, wherein the loop (16) is held on the roll (11) with a pin (17) that runs eccentrically with respect to a rotation axis (12) of the roll (11).
